(19) United States
(12) Patent Application Publication
(10) Pub. No.: US 2025/0067586 A1
(43) Pub. Date: Feb. 27, 2025

(54) METHOD FOR DETERMINING A CHARACTERISTIC PASSAGE TIME OF A COMPONENT OF A HETEROGENEOUS MEDIUM IN A VIBRATING MEASURING TUBE OF A CORIOLIS MASS FLOW METER

(71) Applicant: Endress+Hauser Flowtec AG, Reinach (CH)

(72) Inventors: Hao Zhu, Freising (DE); Alfred Rieder, Landshut (DE); Wolfgang Drahm, Freising (DE); Yaoying Lin, Freising (DE)

(21) Appl. No.: 18/720,940

(22) PCT Filed: Dec. 2, 2022
(86) PCT No.: PCT/EP2022/084223

§ 371 Date: Jun. 17, 2024

(30) Foreign Application Priority Data
Dec. 22, 2021 (DE) 10 2021 134 269.4

(51) Int. Cl. G01F 1/84; G01F 1/74

(52) U.S. Cl. CPC G01F 1/8436; G01F 1/74; G01F 1/8472

(57) ABSTRACT

The method determines a characteristic passage time of a component of a flowing medium in a vibrating measuring tube of a Coriolis mass flow meter. The flow meter has the measuring tube, an exciter for exciting a bending vibration mode of the measuring tube, and a vibration sensor for sensing the measuring tube vibrations. The component is present inhomogenously in the medium and has a component density which deviates from an average density of the medium. The method includes feeding an excitation signal to the exciter with a natural frequency a bending vibration mode, ascertaining at least one first time profile of a signal amplitude of the first vibration sensor at a natural frequency of an anti-symmetrical bending vibration mode, and ascertaining the characteristic passage time on the basis of the first time profile of the signal amplitude at the natural frequency of the anti-symmetrical bending vibration mode.

The present invention relates to a method for determining a characteristic passage time of a component of a heterogeneous medium in a vibrating measuring tube of a Coriolis mass flow meter.

Coriolis mass flow meters are particularly suitable for measuring mass flow rates of essentially incompressible and homogeneous media, as the medium guided in the measuring tube of a Coriolis mass flow meter ideally follows the vibrations of the measuring tube. If a liquid contains microbubbles that are essentially homogeneously distributed in the medium, the onset of compressibility of the medium causes vibrations of the medium relative to the measuring tube, the influence of which can be corrected using multi-frequency technology, for example, as described, for example, in EP 3 394 575 B1. In case of larger, free bubbles, the above correction algorithms of the multi-frequency technology fail. In that case, there are approaches to recognize the occurrence of a free bubble on the basis of a damping of a vibration of the bending vibration useful mode, and to recognize the passage time or passage speed of the bubble, and thus of the medium, on the basis of a duration of the damping. This is described, for example, in EP 2 335 031 B1, EP 2 335 032 B1 and EP 2 335 033 B1. However, this method is disadvantageous in that different bubble sizes or groups of bubbles can simulate a different passage time. It is therefore the object of the present invention to provide a method that overcomes the disadvantages of the prior art.

The object is achieved according to the invention by the method according to independent claim 1.

The method according to the invention is used to determine a characteristic passage time of a component of a flowing medium in at least one vibrating measuring tube of a Coriolis mass flow meter, wherein the Coriolis mass flow meter has the at least one measuring tube, at least one exciter for exciting at least one bending vibration mode of the measuring tube, and at least one vibration sensor for sensing the measuring tube vibrations, wherein the component is present inhomogenously in the medium and has a component density which deviates from an average density of the medium,
Wherein the method comprises the following steps:
Feeding an excitation signal to the exciter with a natural frequency of at least one bending vibration mode;
Ascertaining at least one first time profile of a signal amplitude of the at least one first vibration sensor at a natural frequency of an anti-symmetrical bending vibration mode;
Ascertaining the characteristic passage time on the basis of the at least one first time profile of the signal amplitude at the natural frequency of the anti-symmetrical bending vibration mode.

In a development of the invention, the signal amplitude of the at least one first vibration sensor at the natural frequency of the first anti-symmetrical bending vibration mode is ascertained by means of a spectral analysis.

In a development of the invention, the characteristic passage time is ascertained by means of autocorrelation of the at least one first time profile of the signal amplitude at the natural frequency of the anti-symmetrical bending vibration mode.

In a development of the invention, the Coriolis mass flow meter has at least two vibration sensors, wherein in addition to ascertaining the at least one first time profile of the signal amplitude of the at least one first vibration sensor at a natural frequency of an anti-symmetrical bending vibration mode, the method further comprises ascertaining a second time profile of a signal amplitude of a second one of the vibration sensors at a natural frequency of an anti-symmetrical bending vibration mode.

In a development of the invention, the signal amplitude of the at least second of the vibration sensors at the natural frequency of the first anti-symmetrical bending vibration mode is ascertained by means of a spectral analysis.

In a development of the invention, the characteristic passage time is ascertained by means of a cross-correlation between the first time profile of the signal amplitude at the natural frequency of the anti-symmetrical bending vibration mode and the second time profile of the signal amplitude at the natural frequency of the anti-symmetrical bending vibration mode.

In a development of the invention, at least one of the following variables of the medium is determined on the basis of the characteristic passage time: flow velocity, volume flow rate, mass flow rate and Reynolds number.

In a development of the invention, the component is a minority component which occurs in the medium in the form of spatially discrete structures such as bubbles, droplets or particles.

In a development of the invention, the spatially discrete structures each have a volume which is no more than a quarter, for example no more than an eighth, and in particular no more than a sixteenth of the third power of an internal diameter of the vibrating measuring tube.

In a development of the invention, a structure flowing through the measuring tube causes two deflections in the at least one characteristic of the signal amplitude at the natural frequency of the anti-symmetrical bending vibration mode, wherein the characteristic passage time is a function of the time interval between the two deflections.

In a development of the invention, the method furthermore comprises:
Sensing a time profile of an influence of a plurality of the component's structures on a symmetrical bending vibration mode of the measuring tube;
Ascertaining an average duration between the occurrence of the influence of the structures on the symmetrical bending vibration mode; and
Rejecting the ascertained characteristic passage time if the ascertained mean duration between the occurrence of the influence of the structures on the symmetrical bending vibration mode coincides with the time interval between the two deflections, which corresponds to the ascertained characteristic passage time.

In a development of the invention, the excitation signal comprises exclusively one or more natural frequencies of symmetrical bending vibration modes.

In a development of the invention, the excitation signal comprises at least the natural frequency of the anti-symmetrical bending vibration mode.

In a development of the invention, the excitation signal further comprises a natural frequency of a symmetrical bending vibration mode.

In a development of the invention, the exciter is arranged substantially symmetrical to a longitudinal direction of the measuring tube so that it exerts a force on the measuring tube acting substantially symmetrical to the longitudinal direction of the measuring tube.

The invention is now explained in more detail on the basis of the exemplary embodiments shown in the figures, in which:

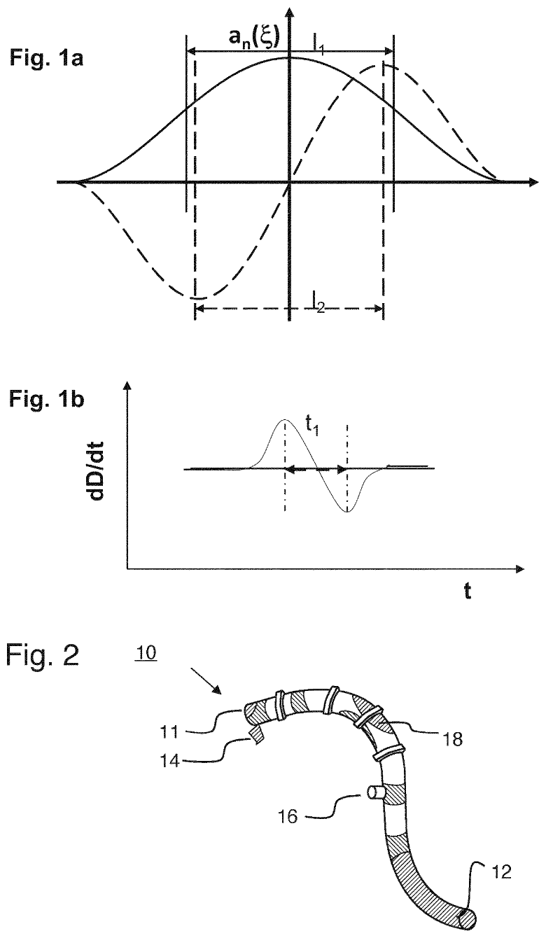

FIG. 1a: shows a diagram with bending lines of a straight measuring tube for different bending vibration modes;

FIG. 1b: shows a diagram for determining the passage time of a media component according to prior art;

FIG. 2: shows simulation results for the deflection of a measuring tube bent in the rest position in the first anti-symmetrical bending vibration mode;

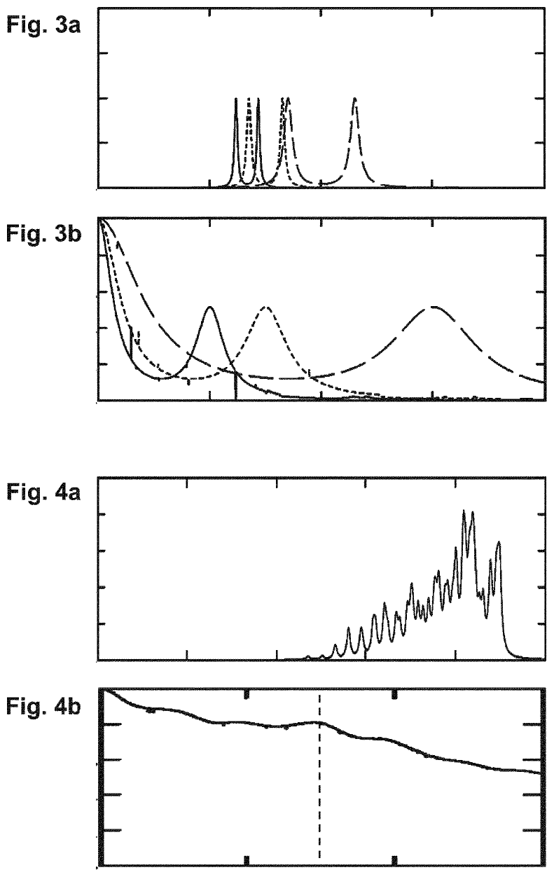

FIG. 3a: shows ideal time profiles of signal amplitudes of a vibration sensor at the natural frequency of the first anti-symmetrical bending vibration mode, in each case when a single bubble is passing through;

FIG. 3b: shows autocorrelation curves of the time profiles of the signal amplitudes of FIG. 3a;

FIG. 4a: shows a time profile of the signal amplitudes of a vibration sensor at the natural frequency of the first anti-symmetrical bending vibration mode when a cluster of bubbles is passing through;

FIG. 4b: shows autocorrelation curves of the time profile of the signal amplitudes of FIG. 4a;

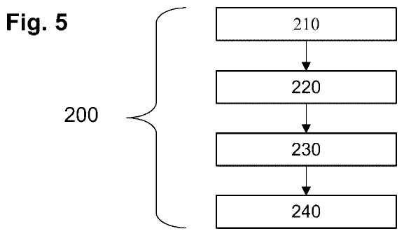

FIG. 5: shows a flowchart of an exemplary embodiment of the method according to the invention.

FIG. 1 shows bending lines aₙ(ξ) for different bending vibration modes of a straight measuring tube which is clamped rigidly at both ends. The first symmetrical bending vibration mode has the maximum deflection in the center of the measuring tube in relation to the longitudinal direction of the measuring tube, as shown with the solid line. This first symmetrical bending vibration mode, also known as the bending vibration useful mode, is usually excited with a symmetrically arranged exciter. The measuring tube shows a constant damping as long as the measuring tube is filled with a homogeneous liquid medium. If, on the other hand, a bubble passes through the measuring tube, this causes a change in the damping D of the measuring tube vibration, wherein the damping scales with the vibration amplitude of the measuring tube at the location of the bubble. The time derivative of damping dD/dt as a function of time shown in FIG. 1b can be used to ascertain a characteristic passage time t₁ between the extremes of the derivative, from which a velocity of the bubble is then ascertained if a characteristic length l₁ outlined in FIG. 1a and ascertained by calibration is known. However, this approach has its limits if the bubble size varies, clusters of bubbles occur, or if there are damping or density fluctuations in the main medium.

Here, the first anti-symmetrical bending mode offers an alternative, as will be explained below. Insofar as it is anti-symmetrical, it has a vibration node in the center of the measuring tube and therefore cannot be excited with a symmetrically arranged exciter under ideal conditions. If, on the other hand, a bubble passes through the measuring tube, it causes an asymmetrical damping and mass distribution in relation to the longitudinal direction of the measuring tube, as a result of which the anti-symmetrical vibration mode becomes excitable. The excitability of the first anti-symmetrical vibration mode is at its maximum when the bubble passes through the extrema of the bending line, shown as a dashed line in FIG. 1a, of the first anti-symmetrical mode. I.e., when a bubble passes through, two vibration maxima occur in chronological order. A characteristic length 12 can be assigned to the spatial distance of the extrema along the measuring tube. If the associated passage time is known, a passage speed is then deducible.

The main difference compared to the approach for determining the passage speed of a bubble on the basis of the damping of the first symmetrical bending vibration mode is that the spatial distance above the vibration maxima is design-dependent so that the signature to be evaluated does not depend on the bubble size or other media properties.

The first anti-symmetrical bending vibration mode is excited to vibrate by a bubble when the symmetry is broken, namely by dissipating energy from the first symmetrical bending vibration mode. It is hence not necessary to drive the exciter also at the natural frequency of the first anti-symmetrical bending vibration mode in order to detect passing bubbles by means of vibration amplitudes occurring in the first anti-symmetrical bending vibration mode. Notwithstanding the above, the exciter can also be excited with the natural frequency of the first anti-symmetrical bending vibration mode, in particular in addition to the natural frequency of the first symmetrical bending vibration mode, wherein a lower signal power is preferably used for the former than for the latter.

The described principle is essentially independent of the shape of the measuring tubes and can of course also be carried out with measuring tubes that are bent in the rest position. FIG. 2 shows an example of simulation results for the deformation of a measuring tube 10 in the first anti-symmetrical bending vibration mode. One half of the measuring tube is shown from the center 11 to one end 12 of the measuring tube at which the measuring tube 10 is clamped rigidly. An exciter 14 is positioned symmetrically in the plane of the center 11 in relation to the longitudinal direction of the measuring tube, and a vibration sensor 16 is arranged between the center 11 and the end 12. In the present case, it is in particular the pronounced deformation or deflection of the measuring tube 10 in a region 18 of a curved section between the center and the vibration sensor 16 that is important. When a bubble passes through this region 18 of the measuring tube 10, the first anti-symmetrical bending vibration mode can be clearly excited. The same applies to a region (not shown) of the measuring tube 10 that is arranged symmetrically in relation to the longitudinal direction of the measuring tube. So when a bubble passes through the bent measuring tube 10, there are two regions of high excitability of the first anti-symmetrical bending vibration mode.

By ascertaining the time profile of the signal amplitude at the natural frequency of the first anti-symmetrical bending vibration mode using spectral analysis, the passage time or passage speed of a bubble can be determined. FIG. 3a shows such a time profile A(t) of ideal signal amplitudes at the natural frequency of the first anti-symmetrical bending vibration mode for a single speed (long dashed line), for example 1 m/s, for a double speed (short dashed line), i.e., 2 m/s in the example, and for a triple speed (solid line), i.e., 3 m/s in the example. Two distinct maxima can be seen in the time profile, the distance between which decreases with increasing speed.

Using autocorrelation, the time interval between the maxima of the signal amplitudes can be ascertained from the time profile. The result of the autocorrelations ACF(τ) with the curves A(t) from FIG. 3a is shown in FIG. 3b, wherein the signature of the lines corresponds to those in FIG. 3a. As expected, maxima can be seen at 3, 1.5 and 1.0 time units. In measuring mode, a characteristic passage time or passage speed can be accordingly determined on the basis of the autocorrelation.

Under process conditions, clusters of several bubbles can of course also be expected. FIG. 4a shows, as an example, the profile A(t) of signal amplitudes at the natural frequency of the first anti-symmetrical bending vibration mode for a cluster of 25 bubbles of different sizes, at twice the flow velocity, i.e., 2 m/s in this case. The corresponding autocorrelation ACF(τ) is shown in FIG. 4b and shows a maximum at 1.5 time units. This confirms that the characteristic passage time or passage speed can be correctly determined even for clusters of bubbles with the method according to the invention.

The autocorrelations ACF can, for example, be determined explicitly as the autocorrelation integral ACF(τ) on the basis of the time profile of the signal amplitudes A(t), i.e., ACF(τ)=integral (A(t) A(t+τ) dt, or according to the Wiener-Khinchin theorem as the Fourier transform of the spectral power density of the time profile of the amplitudes A(t).

Instead of autocorrelation, the passage time can also be determined using a cross-correlation of the time profiles of the signal amplitudes A1(t), A2(t) of two sensors, namely the signal amplitudes of a vibration sensor on the inlet side and of a vibration sensor on the outlet side, which are arranged symmetrically to the center of the measuring tube, in particular in relation to the longitudinal direction.

To summarize, the steps of the method according to the invention will be explained once again with reference to FIG. 5.

The method 200 requires that vibrational energy is present in the measuring tube. In this respect, the method 200 begins with feeding 210 an excitation signal to the exciter with a natural frequency of at least one bending vibration mode. This can be, in particular, the natural frequency of the first symmetrical bending vibration mode, which is usually excited for flow measurement. Feeding the exciter with the natural frequency of the first anti-symmetrical bending vibration mode is not specifically necessary, as sufficient energy is dissipated from the first symmetrical bending vibration mode into the first anti-symmetrical bending vibration mode when the symmetry is broken by a passing bubble. In principle, the method can also comprise feeding the exciter with the natural frequency of the first anti-symmetrical bending vibration mode. Although this does not result in any relevant deflection in case of perfect symmetry, the amplitude of the first anti-symmetrical bending vibration mode becomes all the more pronounced and therefore easier to detect with the onset of broken symmetry due to passing bubbles.

The method 200 further comprises ascertaining 220 a time profile of the signal amplitude of a vibration sensor at a natural frequency of an anti-symmetrical bending vibration mode. For this purpose, the frequency range in which the natural frequency of the first anti-symmetrical bending vibration mode is to be expected can be monitored by means of spectral analysis in order to ascertain the development of the amplitude over time.

This is followed by ascertaining 230 the characteristic passage time on the basis of the at least one first time profile of the signal amplitude at the natural frequency of the anti-symmetrical bending vibration mode.

This is optionally followed by ascertaining 240 a flow velocity, a volume flow rate or a mass flow rate, wherein, in order to ascertain the flow velocity, a quotient is determined from a characteristic length, which describes an effective distance between the maximum deflectable regions of the measuring tube in the first anti-symmetrical bending vibration mode, and the characteristic passage time. The volume flow rate is a function of the flow velocity and of a cross-sectional area of the measuring tube, wherein the mass flow rate results from the volume flow rate and a measured density value of the medium. If the viscosity of the medium is known, which is to be determined, for example, from the ratio between the excitation signal amplitude and the sensor signal amplitude at the natural frequency of the first symmetrical bending vibration mode on the basis of the damping of the first symmetrical bending vibration mode, a Reynolds number can be calculated for the flowing medium on the basis of the flow velocity.

1-15. (canceled)

16. A method for determining a characteristic passage time of a component of a flowing medium in at least one vibrating measuring tube of a Coriolis mass flow meter, wherein the Coriolis mass flow meter has the at least one measuring tube, at least one exciter for exciting at least one bending vibration mode of the measuring tube, and at least one vibration sensor for sensing the measuring tube vibrations, wherein the component is present inhomogenously in the medium and has a component density which deviates from an average density of the medium,
wherein the method comprises the steps of:
feeding an excitation signal to the exciter with a natural frequency of at least one bending vibration mode;
ascertaining at least one first time profile of a signal amplitude of the at least one first vibration sensor at a natural frequency of an anti-symmetrical bending vibration mode;
ascertaining the characteristic passage time on the basis of the at least one first time profile of the signal amplitude at the natural frequency of the anti-symmetrical bending vibration mode.

17. The method according to claim 16, wherein the signal amplitude of the at least one first vibration sensor at the natural frequency of the first anti-symmetrical bending vibration mode is ascertained by means of a spectral analysis.

18. The method according to claim 16, wherein the characteristic passage time is ascertained by means of autocorrelation of the at least one first time profile of the signal amplitude at the natural frequency of the anti-symmetrical bending vibration mode.

19. The method according to claim 16, wherein the Coriolis mass flow meter has at least two vibration sensors, wherein in addition to ascertaining the at least one first time profile of the signal amplitude of the at least one first vibration sensor at a natural frequency of an anti-symmetrical bending vibration mode, the method further comprises ascertaining a second time profile of a signal amplitude of a second one of the vibration sensors at a natural frequency of an anti-symmetrical bending vibration mode.

20. The method according to claim 19, wherein the signal amplitude of the at least second vibration sensor at the natural frequency of the first anti-symmetrical bending vibration mode is ascertained by means of a spectral analysis.

21. The method according to claim 19, wherein the characteristic passage time is ascertained by means of a cross-correlation between the first time profile of the signal amplitude at the natural frequency of the anti-symmetrical bending vibration mode and the second time profile of the signal amplitude at the natural frequency of the anti-symmetrical bending vibration mode.

22. The method according to claim 16, further comprising determining at least one of the following variables of the medium on the basis of the characteristic passage time: flow velocity, volume flow rate, mass flow rate and Reynolds number.

23. The method according to claim 16, wherein the component is a minority component which occurs in the medium in the form of spatially discrete structures.

24. The method according to claim 23, wherein the spatially discrete structures each have a volume which is no more than a quarter of the third power of an internal diameter of the vibrating measuring tube.

25. The method according to claim 23, wherein a structure flowing through the measuring tube causes two deflections in the at least one profile of the signal amplitude at the natural frequency of the anti-symmetrical bending vibration mode, wherein the characteristic passage time is a function of the time interval between the two deflections.

26. The method according to claim 25, furthermore comprising:
Sensing a time profile of an influence of a plurality of the component's structures on a symmetrical bending vibration mode of the measuring tube;
Ascertaining an average duration between the occurrence of the influence of the structures on the symmetrical bending vibration mode; and
Rejecting the ascertained characteristic passage time if the ascertained mean duration between the occurrence of the influence of the structures on the symmetrical bending vibration mode coincides with the time interval between the two deflections, which corresponds to the ascertained characteristic passage time.

27. The method according to claim 16, wherein the excitation signal comprises exclusively natural frequencies of one or more natural frequencies of symmetrical bending vibration modes.

28. The method according to claim 16, wherein the excitation signal comprises at least the natural frequency of the first anti-symmetrical bending vibration mode.

29. The method according to claim 28, wherein the excitation signal further comprises the natural frequency of a symmetrical bending vibration mode.

30. The method according to claim 16, wherein the exciter is arranged substantially symmetrical to a longitudinal direction of the measuring tube so that it exerts a force on the measuring tube that is substantially symmetrical to the longitudinal direction of the measuring tube.
